(19) United States
(12) Patent Application Publication
(10) Pub. No.: US 2007/0158258 A1
(43) Pub. Date: Jul. 12, 2007

(54) MULTIPLE FLOW INTEGRAL FILTRATION MANIFOLD

(76) Inventors: Martin Blaze, Hamden, CT (US); Donald McGibbon, Southington, CT (US); Richard M. Knasel, Marlton, NJ (US); Jerry Fitzgerald, Oswego, IL (US)

Correspondence Address: 3M INNOVATIVE PROPERTIES COMPANY, PO BOX 33427, ST. PAUL, MN, 55133-3427, US

(21) Appl. No.: 11/275,517

(22) Filed: Jan. 11, 2006

(51) Int. Cl. B01D 27/00

(52) U.S. Cl. 210/323.1; 210/443; 222/189.06; 62/389

(57) ABSTRACT

The invention relates to a manifold assembly that is capable of providing at least two effluents, each having different quality characteristics, from a single source inlet.

### BACKGROUND

The invention relates to filtration manifold systems.

Typically, the food service industry uses a single filtration system to reduce particulates, chemicals, and organisms from water used in carbonated and non-carbonated beverages and to reduce scale build-up in ice and/or coffee. For example, a restaurant may use 5,000 gallons (18,925 L) of water to make carbonated beverages and another 20,000 gallons (75,700 L) to make ice and/or coffee annually. Therefore, use of a single water filtration system commonly requires a 25,000-30,000 gallon (94,625-99,625 L) capacity at a flow rate of 4 to 5 gallons per minute (15.1 to 18.9 L per minute).

However, the use of such standard filtration systems can cause bio-film to grow inside an ice machine for example. This is because standard filtration systems commonly remove chlorine/chloramine in addition to cysts and particulates from chlorinated municipal drinking water. Moreover, the use of a chlorine reduction filter for ice machines can be considered a waste, because chlorine does not need to be removed from water used in ice machines. One solution is to install a separate and specific filtration system before each point of use. Although effective, such installations increase the cost of filtering and require inventories of multiple types of filtration cartridges which may be accidentally used improperly on the wrong filtration system.

### SUMMARY

In one aspect, the invention provides a manifold system capable of providing multiple effluent streams, with each having a different water quality due to different impurities being removed in each effluent stream.

In one embodiment, the invention provides an integral manifold assembly comprising:
a manifold comprising a source inlet fluidly connected to at least a first and a second filter port inlet, at least first and second fluid outlets, wherein the first fluid outlet is fluidly connected to a first filter port outlet and the second fluid outlet is fluidly connected to a second filter outlet; and a first replaceable filter cartridge operably and fluidly connected to the first filter port inlet and filter port outlet and a second replaceable filter cartridge operably and fluidly connected to the second filter port inlet and filter port outlet.

### BRIEF DESCRIPTION OF THE DRAWINGS

FIG. 1 is a perspective view of a manifold assembly of the invention;

FIG. 2 is an isometric top view of a manifold described herein; and

FIG. 3 is a schematic view of the manifold of FIG. 2 from the bottom.

### DETAILED DESCRIPTION

The manifold systems of the invention are capable of providing multiple qualities of effluent. Multiple qualities of effluent are obtained by passing an inlet fluid into a manifold assembly including an integral manifold having multiple fluid channels and fluid outlets and at least one filter for each channel and outlet. For example, the integral manifold may have one source fluid inlet and two fluid outlets. Fluid from the inlet is directed through a first channel that directs the fluid through a first filter cartridge to a first fluid outlet and through a second channel through a second filter cartridge to a second filter outlet. For example, the first filter may be adapted to reduce cysts, particulates, turbity, and scale. And the second filter may be adapted to reduce cysts, chlorine, chloramines, and particulates. In this way, one effluent stream containing chloride/choramine may be used in applications where such contaminants can be tolerated and/or are useful for reducing the growth of biological matter. In other embodiments of the invention, other combinations of reduction capabilities can be used, for example, first filter cartridge (1) particulate reduction, second filter cartridge, (2) particulate reduction and cyst reduction; (1) particulate reduction, (2) particulate reduction, turbidity reduction, and cyst reduction; (1) particulate reduction, (2) particulate reduction, turbidity reduction, chlorine reduction, and cyst reduction; (1) particulate reduction and bacteria reduction, (2) particulate reduction, bacteria reduction, and chloramines reduction; and any combination thereof.

In other embodiments, multiple filters can be used to filter each fluid stream. For example, multiple filters could be used to filter each fluid stream in series, that is, through the first filter then the second, or in parallel, that is, both filters at the same time. In this way, the manifold systems of the invention may be configured to provide multiple effluents having different quality characteristics. The most common fluid to be filtered is water.

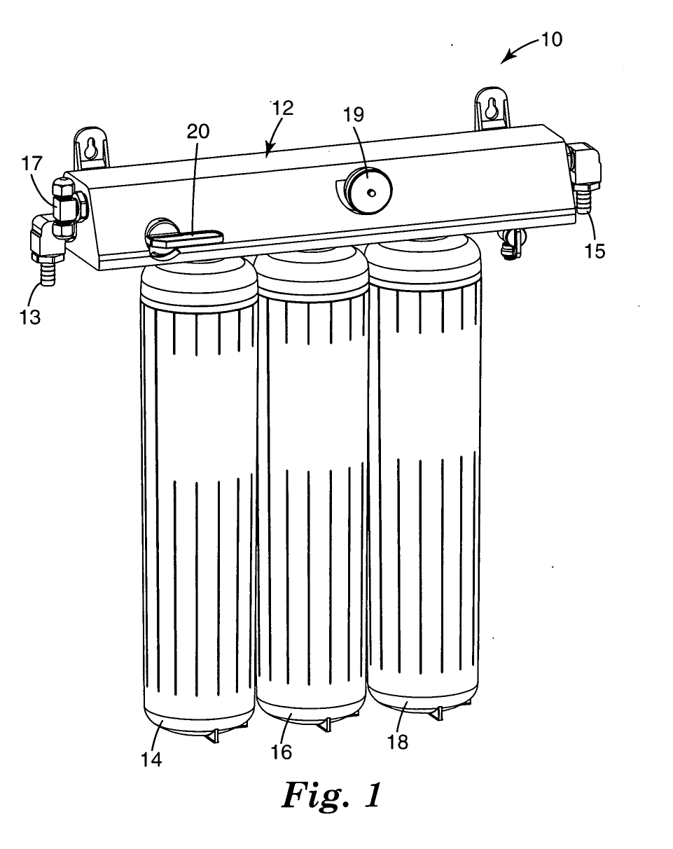

FIG. 1 shows an embodiment of a filtration assembly 10 of the invention. Filtration assembly 10 includes an integral multi-flow manifold 12 having replaceable filter cartridges 14, 16, 18 operably and fluidly attached to the manifold. Multi-flow manifold 12 has a fluid source inlet connection 13 and first and second fluid outlet connections 15, 17. Also shown in this embodiment, the manifold includes a pressure gauge 19 for monitoring the pressure of one effluent water stream and a manual valve 20 for blocking the fluid source to enable replacement of the filter cartridges when required. Multiple pressure gauges and valves may be used to monitor the pressure of and direct the flow of the fluid in the respective channels.

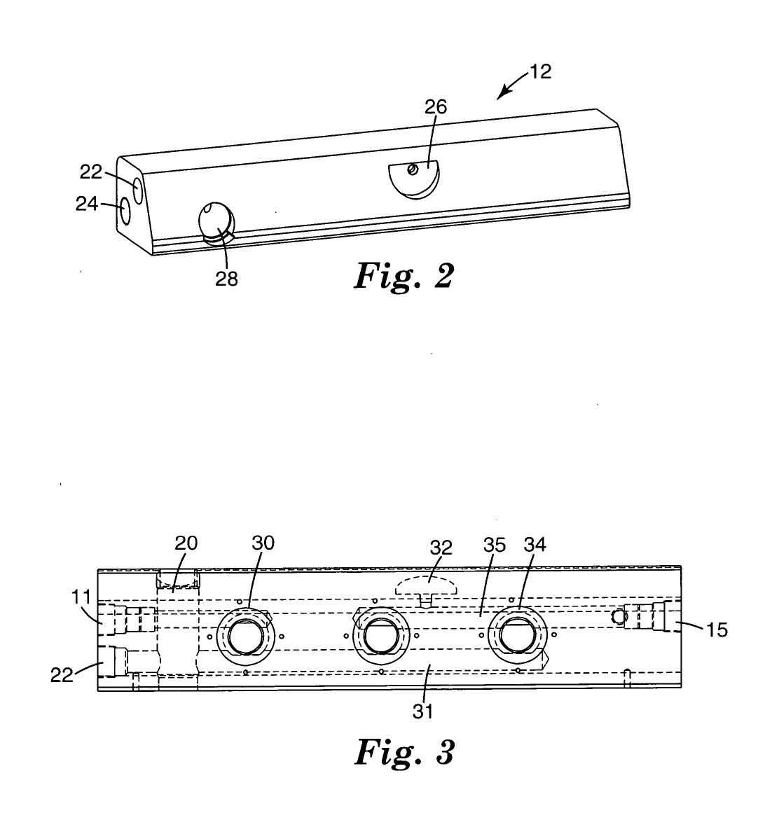

FIG. 2 is an isometric top view of the multi-flow manifold shown in FIG. 1, showing fluid source inlet 22, second fluid outlet 24, pressure gauge mounting aperture 26, and valve bore 28.

FIG. 3 is a schematic view of the manifold of FIG. 2 from the bottom of the manifold. In this embodiment, the manifold has three filter inlet ports 30, 32, 34 fluidly connected to the fluid source inlet 22 via an internal source inlet channel 31. Filter port 30 is also fluidly connected to the second fluid outlet 11 via a second outlet channel 33. In this embodiment, filter ports 32 and 34 are also fluidly connected to the first fluid outlet 15 via a common first outlet channel 35 such that the filter cartridges 16 and 18 when attached to the manifold, filter water in parallel. In other embodiments, the filter inlet ports 32 and 34 can be adapted such that the fluid flow runs through the respective filter cartridges in series.

The replaceable filter cartridges typically comprise a filter housing, filtration media inside the housing, and a connector for operably and fluidly attaching the cartridge to the filter attachment mechanism on the manifold. The connector has both a filter fluid inlet and a filter fluid outlet to allow fluid to enter and exit the filter. Examples of useful filtration media include synthetic membranes, non-woven polymers, carbon block, polymer block, granular carbon, and ion exchange resins. Examples of such connectors on the filter cartridge include bayonet and threaded connectors. The attachment mechanisms on the manifold are adapted to accept the connectors on the filter cartridge.

The replaceable filter cartridges can comprise a removably replaceable filter such as, for example, a replaceable cartridge filter as described in U.S. Pat. Nos. 6,458,269; 6,949,189; and 6,513,666, all of which are herein incorporated by reference to the extent not inconsistent with the present disclosure. Suitable replaceable filter cartridges are also commercially available from Cuno Incorporated, Meriden, Conn.

In operation, the filtration manifold 10 would be connected via the inlet connection 13 to a fluid source, for example, a water line. The water flows into the fluid source inlet 22, through the source inlet channel 31 to the filter inlet ports 30, 32, 34. As shown in FIG. 3, in this embodiment, filter fluid from filter 14 enters the second outlet channel 33 and is directed out of the second fluid outlet 11. The effluent from second fluid outlet 11 will have certain quality characteristics based on the type of filter media used. In this embodiment, fluid is also directed into the first outlet channel 35 from the filters 16, and 18 in parallel, and the filtered fluid is directed out of the first outlet 15.

The integral manifolds described herein can be machined from polymeric and/or metal sheet and bar stock. It is contemplated that the manifolds may also be injection molded from polymeric material or cast from metals. Useful materials include materials that comprise polyethylene, polypropylene, nylon, steel, stainless steel, and combinations thereof.

Foreseeable modifications and alterations of this invention will be apparent to those skilled in the art without departing from the scope and spirit of this invention. This invention should not be restricted to the embodiments that are set forth in this application for illustrative purposes.

What is claimed is:

1. An integral manifold assembly comprising:
a manifold comprising a source inlet fluidly connected to at least a first and a second filter port inlet,
at least first and second fluid outlets, wherein the first fluid outlet is fluidly connected to a first filter port outlet and the second fluid outlet is fluidly connected to a second filter outlet; and
a first replaceable filter cartridge operably and fluidly connected to the first filter port inlet and filter port outlet and a second replaceable filter cartridge operably and fluidly connected to the second filter port inlet and filter port outlet.

2. The integral manifold assembly of claim 1 further comprising a third replaceable filter cartridge operably and fluidly connected to a third filter port inlet and outlet, the second fluid outlet is fluidly connected to the third filter port outlet.

3. The integral manifold assemble of claim 1 wherein the first replaceable filter cartridge contains filter media adapted to reduce particulates and the second filter cartridge is adapted to reduce particulates and cysts.

4. The integral manifold assemble of claim 1 wherein the first replaceable filter cartridge contains filter media adapted to reduce particulates and the second replaceable filter cartridge contains filter media adapted to reduce cysts, chlorine, chloramines, and particulates.

5. The integral manifold of claim 1 wherein the source inlet is fluidly connected to the first and second filter port inlets by a channel.

6. The integral manifold of claim 1 wherein the filter cartridges are operably and fluidly connected to the filter port inlets and outlets by a threaded or bayonet connector.

7. An integral manifold assembly comprising:
a manifold comprising a source inlet fluidly connected to at least a first and a second filter port inlet,
at least first and second fluid outlets, wherein the first fluid outlet is fluidly connected to a first filter port outlet and the second fluid outlet is fluidly connected to a third filter port outlet; and
a first replaceable filter cartridge operably and fluidly connected to the first filter port inlet and filter port outlet, a second replaceable filter cartridge operably and fluidly connected to the second filter port inlet and second filter port outlet, the second filter port outlet being fluidly connected to a third filter port inlet.

8. The manifold assembly of claim 7 wherein the filter cartridges are operably and fluidly connected to the filter port inlets and outlets by a threaded or bayonet connector.

9. The manifold assembly of claim 7 further comprising an outlet channel fluidly connecting the third filter port outlet and the second fluid outlet and a fluid pressure monitor adapted to measure fluid pressure of fluid within the outlet channel.

10. The manifold assembly of claim 4 wherein the first fluid outlet is fluidly connected to an ice machine.

11. The manifold of claim 4 wherein the second fluid outlet is fluidly connected to a dispenser that provides carbonated beverages, non-carbonated beverages, or a combination of both.

12. A system for providing beverages and ice comprising:
an integral manifold assembly comprising:
a manifold comprising a source inlet fluidly connected to at least a first and a second filter port inlet,
at least first and second fluid outlets, wherein the first fluid outlet is fluidly connected to a first filter port outlet and the second fluid outlet is fluidly connected to a second filter outlet; and
a first replaceable filter cartridge containing filter media adapted to reduce particulates operably and fluidly connected to the first filter port inlet and filter port outlet and a second replaceable filter cartridge containing filter media adapted to reduce cysts, chlorine, chloramines, and particulates operably and fluidly connected to the second filter port inlet and filter port outlet;
an ice making machine fluidly connected to the first fluid outlet; and
a beverage dispenser fluidly connected to the second fluid outlet.
